(19) United States
(12) Patent Application Publication
(10) Pub. No.: US 2005/0288056 A1
(43) Pub. Date: Dec. 29, 2005

(54) System including a wireless wide area network (WWAN) module with an external identity module reader and approach for certifying the WWAN module

(76) Inventors: Sundeep M. Bajikar, Santa Clara, CA (US); Francis X. McKeen, Portland, OR (US); Ramgopal K. Reddy, Portland, OR (US); Kelan C. Silvester, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,658

(22) Filed: Jun. 29, 2004

(51) Int. Cl. H04M 1/66

(52) U.S. Cl. 455/554.2

(57) ABSTRACT

A computing system includes a wireless wide area network (WWAN) module and an identity module reader external to and accessible by the WWAN module to receive an identity card to provide credentials to be accessed by the WWAN module. A platform to test such a system includes a WWAN module, an identity module reader external to the WWAN module to receive an identity card storing credentials to be accessed by the WWAN module and an identity card interface component coupled to the WWAN module and identity module reader, the identity module interface component to substantially emulate an interface between the WWAN module and the identity module reader in a computing platform in which the WWAN module and identity module reader are to be implemented.

### CROSS-REFERENCE TO RELATED APPLICATION

This application is related to co-pending U.S. patent application Ser. No. 10/715,970 entitled, “Method and System To Provide A Trusted Channel Within A Computer System For A SIM Device,” Attorney Docket Number 42P18073, assigned to the assignee of the present invention and filed Nov. 17, 2003.

### BACKGROUND

An embodiment of the present invention relates to the field of computing systems and, more particularly, to a system including a wireless wide area network (WWAN) module associated with an external Identity Module reader and/or to an approach for testing and/or certifying such a WWAN module.

Currently, a hardware Subscriber Identity Module (SIM) device accessed by an associated reader may be used to provide user authentication to a GSM/GPRS (Global System for Mobile communications/General Packet Radio Services) network for authorization and accounting purposes. The overall purpose of the SIM device is referred to as Authentication, Authorization and Accounting (AAA). Typically SIM devices and associated readers are located within the mobile equipment, such as a wireless telephone or other wireless wide area network (WWAN) device, for which they provide AAA capabilities.

Currently, ME modules, including WWAN modules, must pass Formal Type Approval (FTA) testing before they can be sold commercially. Those seeking FTA certification typically provide the ME to be sold to an FTA test house to perform the necessary tests. For example, for each new wireless telephone to be sold by a manufacturer, the manufacturer may provide the telephone itself to the FTA test house for performance of the FTA certification process.

### BRIEF DESCRIPTION OF THE DRAWINGS

The present invention is illustrated by way of example and not limitation in the figures of the accompanying drawings in which like references indicate similar elements, and in which:

FIG. 1 is a high-level block diagram of a computing system of one embodiment including a wireless wide area network (WWAN) module associated with a Subscriber Identity Module (SIM) reader outside the WWAN module.

FIG. 2 is a high-level block diagram of a computing system of another embodiment including a WWAN module associated with an external SIM reader wherein trusted channels are provided between software and the WWAN module and/or between software and the SIM reader.

FIG. 3 is a high-level diagram illustrating software modules and software/hardware interaction of FIG. 2 in more detail.

FIG. 4 is a high-level block diagram of an arrangement of one embodiment for certification testing of a WWAN module, such as the WWAN module of FIG. 1.

FIG. 5 is a high-level block diagram of an arrangement of another embodiment for certification testing of a WWAN module.

FIG. 6 is a high-level flow diagram showing a method of one embodiment for authenticating a user of a wireless wide area network by accessing a credential reader outside of a WWAN module.

### DETAILED DESCRIPTION

A system including a wireless wide area network (WWAN) module associated with an external Identity Module reader, and approach for certifying the same are described. In the following description, particular components, types of identity modules, software modules, protocols, buses, systems, certification testing etc. are described for purposes of illustration. It will be appreciated, however, that other embodiments are applicable to other types of components, types of identity modules, protocols, buses, software modules, certification testing, and/or systems, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

For one embodiment, an apparatus includes a Wireless Wide Area Network (WWAN) module to provide for wireless communications. A Subscriber Identity Module (SIM) or other credential reader external to the WWAN module is accessible by the WWAN module. The SIM reader is to receive a SIM card or other credential store to be accessed by the WWAN module. While a SIM reader and associated SIM card are referenced in the illustrative embodiments described below, it will be appreciated that other types of credential or identity module readers and associated credential stores or identity modules may be used for various embodiments including, for example, a Universal SIM (USIM) card, a Removable User Identity Module (R-UIM) card, and a Universal Serial Bus (USB) Integrated Chip Card (UICC). Other types of credential stores are within the scope of various embodiments.

For another embodiment, an apparatus includes a WWAN module coupled to a first bus and a Subscriber Identity Module (SIM) or other credential reader external to the WWAN module coupled to a second bus. The credential reader is to receive a SIM card or other credential store storing credentials to be accessed by the WWAN module. Where the credential store is a SIM card, a SIM interface component is further coupled to the WWAN module and SIM reader over the first and second buses, respectively. The SIM interface component is to substantially emulate a SIM/WWAN module interface provided by a computing system in which the WWAN module and SIM reader are to be implemented. An analogous interface component may be used for a similar purpose for other types of credential stores and associated readers.

Further details of these and other embodiments are provided in the description that follows.

Embodiments of the invention may be implemented in one or a combination of hardware, firmware, and software. Embodiments of the invention may also be implemented in whole or in part as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

In the description that follows, the terms protected or trusted areas or paths may refer to areas of a device or paths between devices that have sufficient protections associated with them to prevent access to them by unauthorized devices and/or software. Further, the terms trusted software or code may refer to software that has been validated through some means to verify that it has not been altered in an unauthorized manner before execution.

Using SIM cards as an example, while SIMs are currently most commonly used in wireless telephones, the authentication, authorization and accounting (AAA) features of SIM devices may also be useful in other environments and/or for other types of applications. For example, security is an increasingly important issue for personal and other computing platforms. In particular, with the growth of the Internet, wireless communications and connected Mobile computing, personal computers, including notebook computers, are more frequently being used for e-commerce and other applications where data security is of paramount importance. Thus, there is a growing need to increase the trustworthiness of computer systems.

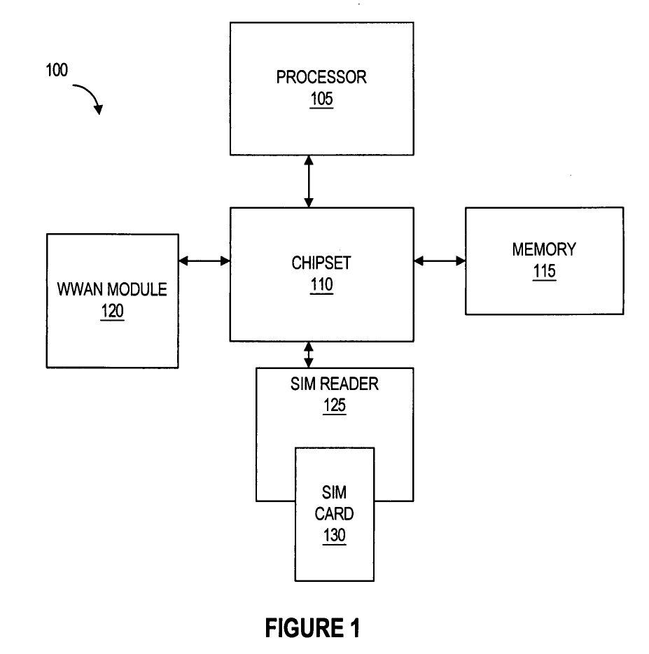

FIG. 1 is a block diagram of a computing system 100 of one embodiment that may advantageously include or be coupled to a WWAN module, and an external credential or identity module reader, such as a SIM reader to be accessed by the WWAN module.

The computing system 100 may, for example, be a personal computing system such as a notebook or desktop computing system. Alternatively, the computing system may be an enterprise or workstation computing system, a personal digital assistant or another type of computing system or device.

For the exemplary computing system 100, a processor 105 is coupled to a chipset 110. The chipset 110 may include, for example, memory control, input/output control and/or graphics control modules provided by one or more integrated circuits. The chipset 110 is coupled to a memory 115, which may include a main system memory, read-only memory and/or a cache memory, each of which may store information and/or instructions to be used by the processor 105.

For the embodiment shown in FIG. 1, the chipset is also coupled to a Wireless Wide Area Network (WWAN) module or another type of Mobile Equipment (ME) module 120 that does not include an integrated Subscriber Identity Module (SIM) or other credential store. The WWAN module 120 of some embodiments may also include other network connectivity component(s) such as wireless local area network (WLAN), local area network (LAN) and/or ultra wide band (UWB) component(s), for example. Also coupled to the chipset 110 is a SIM or other credential reader 125 that is external to and accessible by the WWAN module 120. The credential reader 125 is configured to receive a SIM card or another type of credential module 130. It will be appreciated that other modules and/or components may be included in the system 100 for various embodiments.

By providing the SIM reader 125 outside of the WWAN module 120, the SIM reader 125 and associated SIM card 130 may be used to provide authentication-related capabilities for modules and/or applications other than the WWAN module 120 in addition to providing authentication for the WWAN module 120.

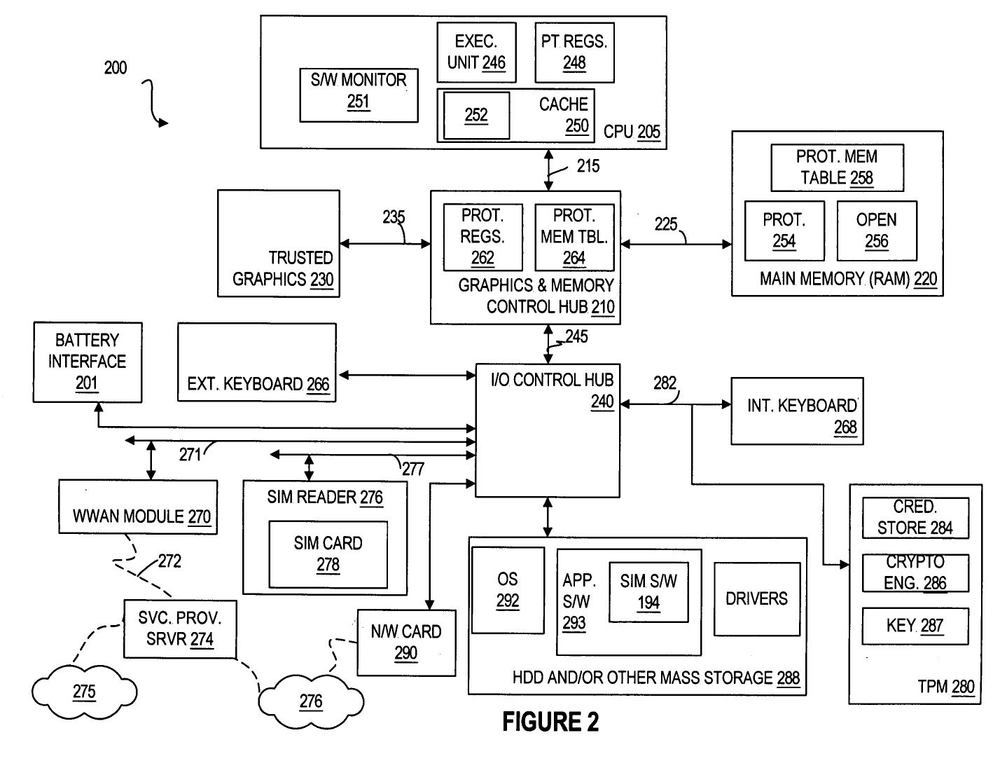

FIG. 2 is a block diagram of an exemplary computing system 200 of another embodiment for which trusted paths are provided between one or more of a WWAN module and a SIM or other credential (or identity module) reader external to the WWAN module and associated software. As for the embodiment of FIG. 1, the credential reader is accessible by the WWAN module, but may also be used by other modules or applications.

The computing system 200 may, for example, be a mobile computing system such as a notebook or laptop computer. Alternatively, the computing system 200 may be a different type of computing system such as a desktop computer, a workstation computer, a personal digital assistant, or another type of computing device. Where the computing system 200 is a mobile computing system, or another type of system that may operate without an alternating current power supply, a battery and/or battery connector 201 may be included and coupled to the system 200 in a conventional manner to provide an alternate or primary power source for the computing system 200.

The computing system 200 includes a central processing unit (CPU or processor) 205 coupled to a graphics and memory control hub (GMCH) or other memory and/or graphics controller 210 via a processor bus 215, a main memory 220, which may comprise, for example, random access memory (RAM) or another type of memory, coupled to the GMCH 210 over a memory bus 225, and an input/output (I/O) control hub (ICH) or other I/O controller 240, which may be coupled to the GMCH 210 over a bus 245. The graphics and memory controller (or GMCH) 210 and the I/O controller (or ICH) 240 may be referred to collectively as the chipset.

The chipset may be a logic circuit to provide an interface between the processor 205, the memory 220, and other devices. For one embodiment, the chipset may be implemented as one or more individual integrated circuits as shown in FIG. 2, but for other embodiments, the chipset, or one or more features of the chipset, may be implemented as a portion of a larger integrated circuit or as parts of multiple other integrated circuits. Although individually labeled herein as a graphics and memory controller and I/O controller, these labels should not be read as a limitation on how the chipset features may be physically implemented.

The processor 205 of one embodiment may be an Intel© architecture microprocessor that implements a technology, such as Intel Corporation's Lagrande technology (also referred to herein as LT), that provides for protected execution along with other security-oriented features. Some details of Lagrande technology may currently be found, for example, at http://www.extremetech.com/article2/0,3973,1274197,00.asp and in other publicly available documentation.

For other embodiments, the CPU 205 may be another type of processor such as, for example, an embedded processor, a digital signal processor, a microprocessor from a different source, having a different architecture and/or a different security technology, etc. and/or more than one processor and/or a processor including multiple cores may be included. The processor 205 may include an execution unit 246, page table (PT) registers 248, one or more on-chip and/or off-chip cache memories 250 and a software monitor 251.

All or part of the cache memory 250 may include, or be convertible to, protected memory 252. Protected memory, as described above, is memory with sufficient protections to prevent access to it by an unauthorized device (e.g., any device other than the associated processor 205) while activated as a protected memory. In the illustrated embodiment, the cache memory 250 may have various features to permit its selective isolation as a protected memory. The protected memory 252 may alternatively or additionally be external to and separate from the cache memory 250 for some embodiments, but still associated with the processor 205.

PT registers 248 may be used to implement a table to identify which memory pages are to be accessible only by trusted code, i.e. protected, and which memory pages are not to be so protected.

The trusted software (S/W) monitor 251 may monitor and control the overall protected operating environment once the protected operating environment has been established. The software monitor may alternatively be provided on the memory controller 210 or elsewhere in the system 200. In some embodiments, the trusted S/W monitor 251 may be located in a protected memory such as the memory 252 such that it is itself protected from unauthorized alterations.

The processor 205 may further be capable of executing instructions that provide for protected execution of trusted software. For example, the execution unit 246 may be capable of executing instructions to isolate open and protected partitions in on-chip (e.g. the cache memory 250) and off-chip memory (e.g. the main memory 220) and to control software access to protected memory.

The GMCH 210 of one embodiment may provide for additional memory protection to block device accesses (e.g. DMA accesses)) to protected memory pages. For some embodiments, this additional memory protection may operate in parallel to the execution of the above-described instruction(s) by the CPU 205 to control software access to both on and off-chip protected memory to mitigate software attacks.

For example, the GMCH 210 may include protected registers 262, and a protected memory table 264. In one embodiment, the protected registers 262 are registers that are writable only by commands that may only be initiated by trusted microcode (not shown) in the processor 205. Trusted microcode is microcode whose execution may only be initiated by authorized instruction(s) and/or by hardware that is not controllable by unauthorized devices.

The protected registers 262 may hold data that identifies the locations of, and/or controls access to, the protected memory table 264 and the trusted S/W monitor 251. The protected registers 262 may include a register to enable or disable the use of the protected memory table 264, so that DMA protections may be activated before entering a protected operating environment and deactivated after leaving the protected operating environment, for example. Protected registers 262 may also include a writable register to identify the location of the protected memory table 264, so that the location does not have to be hardwired into the chipset.

For one embodiment, the protected registers 262 may further store the temporary location of the trusted S/W monitor 251 before it is placed into protected locations of the memory 220, so that it may be located for transfer when the protected operating environment provided by the system 200 is initialized. For one embodiment, the protected registers 262 may include an execution start address of the trusted S/W monitor 251 after the transfer into memory 220, so that execution may be transferred to the trusted S/W monitor 251 after initialization of the protected operating environment.

The protected memory table 264 may define the memory blocks (where a memory block is a range of contiguously addressable memory locations) in the memory 220 that are to be inaccessible for direct memory access (DMA) transfers and/or by other untrusted sources. Since all accesses associated with the memory 220 are managed by the MCH 210, the MCH 210 may check the protected memory table 164 before permitting any DMA or other untrusted transfer to take place.

For one embodiment, the protected memory table 264 may be implemented as a table of bits, with each bit corresponding to a particular memory block in the memory 220. In a particular operation, the memory blocks protected from DMA transfers by the protected memory table 264 may be the same memory blocks restricted to protected processing by the PT registers 248 in the processor 205.

The main memory 220 may include both protected 254 and open 256 memory pages or partitions. Access to protected pages or partitions 254 in memory 220 is limited by the CPU 205 and/or the MCH 210 to specific trusted software and/or components as described in more detail herein, while access to open pages or partitions in the memory 220 is according to conventional techniques.

As illustrated in FIG. 2, the main memory 220 may further include a protected memory table 258. For one embodiment, the protected memory table is implemented in the GMCH 210 as the protected memory table 264 as described above and the protected memory table 258 may be eliminated. For another embodiment, the protected memory table is implemented as the protected memory table 258 in the memory 220 and the protected memory table 264 may be eliminated. The protected memory table may also be implemented in other ways not shown. Regardless of physical location, the purpose and basic operation of the protected memory table may be substantially as described.

With continuing reference to FIG. 2, where the computing system 200 is a mobile computing system, such as, for example, a laptop or notebook computer, the ICH 240 may be coupled to both an external keyboard 266 and an internal keyboard 268. For other types of systems and/or for some mobile systems, only one of the external and internal keyboards may be provided. A secure or trusted path between the external 266 and/or internal keyboard 268 and trusted software is provided to protect the trusted partition of the system 200 from untrusted inputs or other types of attacks. For one embodiment, this secure path may be in accordance with, for example, copending patent application Ser. No. 10/609,828 entitled, “Trusted Input for Mobile Platforms Transactions,” filed Jun. 30, 2003 and assigned to the assignee of the present invention.

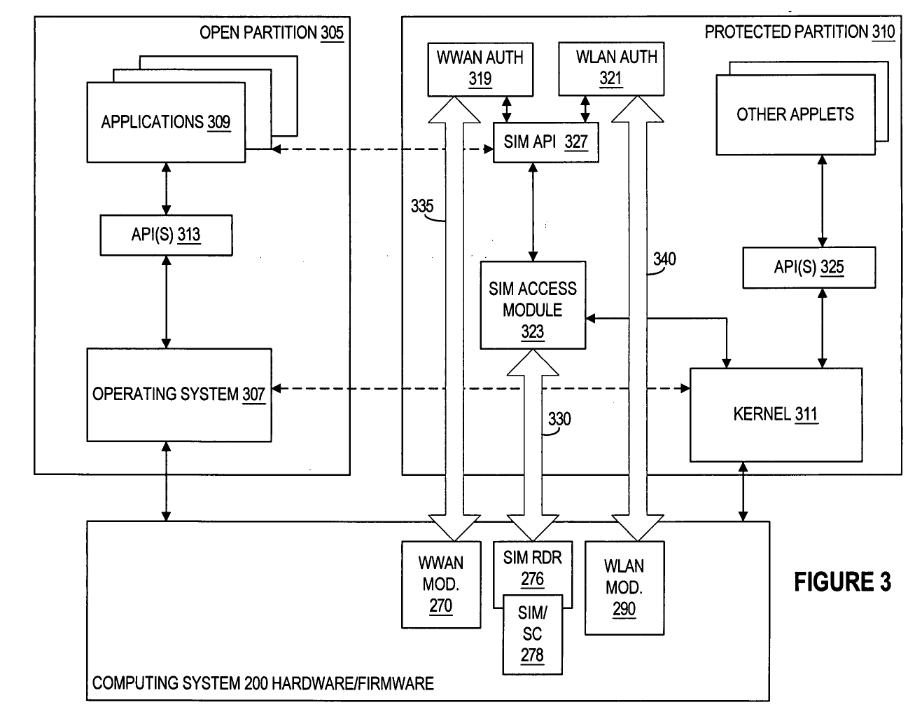

A wireless wide area network (WWAN) module or add-in card or other mobile equipment module 270 may also be coupled to the ICH 240 over a bus 271. The bus 271 of one embodiment is a Universal Serial Bus (USB), but may be a different type of bus, such as, for example, a Peripheral Component Interconnect (PCI) or a PCI Express (PCIE) bus for other embodiments. Other types of buses may be used for still other embodiments. For some embodiments, a trusted connection is provided between the WWAN module 270 and a protected partition of the computing system 100 as described in more detail below in reference to FIG. 3.

The WWAN module 270 may provide for wireless connectivity over a wireless network 272, which may be operated/serviced by a telephone company (telco) or other service provider and/or may be used by a service provider to provide services to the computing system 200. For such an example, the WWAN module 270 may enable the computing system 200 to be coupled to a remote server 274, such as a server operated by the service provider, over the wireless network 272. The server 274 may further provide connections to one or more other networks 275 and/or 276 such as the Internet.

The network 272 and/or the network 275 may be a GSM/GPRS (Global System for Mobile communications/General Packet Radio Services) network, for example. Other types of wireless network protocols such as, for example, CDMA (Code Division Multiple Access), PHS (Personal Handyphone System), 3G (Third generation services) networks, etc. are also within the scope of various embodiments.

A Subscriber Identity Module (SIM) other type of credential or identity module reader 276 may also be coupled to the ICH 240 via a bus 277. The bus 277 may be any one of a variety of different types of buses such as, for example, a USB or a PCIE bus. For some embodiments, the bus 277 may be a virtual bus such as a Bluetooth™ link. For some embodiments, the SIM reader 276 may be provided within the computing system 200. For other embodiments, the SIM reader 276 may be external to the computing system 200 and the link 273 may be externally accessible.

The SIM or other type of reader 276 may provide an interface for a SIM card 278 or other credential to be used with the system 200. For the embodiment of FIG. 2, the SIM reader 276 is external to the WWAN module 270 as shown and is accessible by the WWAN module 270 via the WWAN module's connection to the computing system 200 over the bus 271. The computing system 200 provides the necessary hardware and software support for any SIM access requests from the WWAN module 270, or from other devices or applications accessible by, within or running on the computing system 200.

The connection 277 between the SIM reader 276 of one embodiment and the ICH 240 or between the SIM card 278 itself and the ICH 240 is a trusted connection such that a secure link between the SIM card 278 and a protected partition of the system 200 is provided once a protected partition is established. The trusted connection may be provided in the manner described below in reference to FIG. 3, in accordance with co-pending U.S. patent application Ser. No. 10/715,970 entitled, “Method and System To Provide A Trusted Channel Within A Computer System For A SIM Device,” Attorney Docket Number 42.P18073, assigned to the assignee of the present invention and filed Nov. 17, 2003, or using a different approach.

With continuing reference to FIG. 2, a hardware token such as a Trusted Platform Module (TPM) 280, which may be in accordance with a currently available or future revision of the TPM specification, currently version 1.1, available from the Trusted Computer Platform Alliance (TCPA) and version 1.2 of the Trusted Computing Group (TCG), may also be coupled to the ICH 240 over, for example, a low pin count (LPC) bus 182 The TPM 180 may be provided to protect data related to creating and maintaining a protected operating environment, and is associated directly with the computing system 200. In other words, the hardware token 280 is not moved from system to system.

For one embodiment, the hardware token 280 is a discrete hardware device that may be implemented, for example, using an integrated circuit. For another embodiment, the hardware token 280 may be virtualized, i.e. it may not be provided by a physically separate hardware chip on the motherboard, but may instead be integrated into another chip, or the capabilities associated with a TPM or other hardware token as described herein may be implemented in another manner.

The TPM 280 of one embodiment may include a credential store 284, which may comprise non-volatile memory, to store password and credential information associated with the system 200. The TPM 280 of one embodiment may further include a cryptographic engine 286, digital signatures (not shown), a hardware random number generator (not shown) and/or monotonic counters (not shown).

The TPM 280 has a locked state in which information stored in the credential store 284 is inaccessible or otherwise protected, and an unlocked state in which information stored in the credential store 284 may be accessible by certain software or components. In particular embodiments, the hardware token 280 may include a key 287, which may be an embedded key to be used for specific encryption, decryption and/or validation processes.

A hard disk drive (HDD) and associated storage media and/or other mass storage device 288, such as a compact disc drive and associated compact disc read-only memory (CD_ROM), may also be coupled to the ICH 240. While only one mass storage reference block 288 is shown in FIG. 2, it will be appreciated that multiple mass storage devices of various types may be used to implement the mass storage device 288. Further, additional storage devices may be accessible by the computing system 200 over the network 272 or over another network 276 that may be accessed via a wireless local area network (WLAN) card, another type of network card, modem or other wired communications device 290, for example.

The computing system 200 may further run an operating system 292 that provides for open and protected partitions for software execution. For one embodiment, the operating system 292 may be provided by Microsoft Corporation of Redmond, Wash., and may incorporate Microsoft's Next-Generation Secure Computing Base (NGSCB) technology. Alternatively, the operating system 292 may be a different type of operating system such as, for example, a Linux operating system.

Other software, such as application software and/or application programming interfaces (APIs) 293, which may include one or more programs 294 that assist with interaction with the SIM card 278 and/or SIM reader 276 or make use of the AAA capabilities provided by the SIM card 278 and associated authentication routines, may also be stored on the mass storage device 288 or in another memory of the system 200. Drivers 295, such as SIM reader and/or WWAN module drivers may also be stored. The operating system 292 and program(s) 293 and 295 are shown as being stored on the mass storage device 288, but all or part of the operating system 292 and/or program(s) 293 and/or 295 may be stored in another storage device on or accessible by the computing system 200.

FIG. 3 is a conceptual diagram illustrating at a high level some aspects of the hardware/software interface and various partitions that may be provided by the operating system 292 of FIG. 2 when a secure operating environment has been established for one embodiment.

An open partition 305 provided by the operating system 292 runs the main operating system 307, drivers 295 (FIG. 2), applications 309 and associated APIs 313. A protected partition 310 includes a protected operating system kernel 311 and protected applets or applications such as one or more SIM-related, WWAN-related and/or WLAN-related applications 319, 321 and/or 323 that may be part of the software 293 (FIG. 2). Associated API(s) 325 and 327 may also be included.

In order to meet the SIM presence requirement for Formal Type Approval (FTA) certification, for example, the WWAN module 290 needs to be able to continually or periodically verify that the SIM card 278 is logically connected to the computing system 100 for the duration of an ongoing voice or data call over the WWAN. For currently available computing systems, it is possible for a malicious software program to fake a SIM card presence “heartbeat” to a WWAN module because currently available protections for communications between a WWAN module and a SIM card external to a WWAN module are insufficient to prevent such actions.

For one embodiment, it is possible to provide trusted communication paths between a WWAN module or other ME module, a credential or identity module reader or card and trusted software to provide protections for communications between the WWAN module 270 and software such as SIM presence heartbeat, transmission of the secret key Kc, which may be generated using the SIM card 278 and manageability functions, for example. Manageability functions may include functions such as updating algorithms within the WWAN module, updating a security policy, updating network preferences, etc.

To implement such protections, for some embodiments, a SIM access module 323 provides a trusted channel 330 between the SIM reader 276 and/or card 278, over the bus 277 (FIG. 2), and the protected partition 310 once the protected partition has been established. The SIM access module 323 may provide this trusted channel according to one of the approaches described above in reference to FIG. 2, for example. Other approaches for providing a trusted channel are within the scope of various embodiments.

WWAN and/or WLAN authentication software 319 and/or 321 may also be provided and runs as a trusted application in the protected partition 310. The WWAN and/or WLAN authentication software 319 and 321 may provide trusted channels 335 and 340, respectively. The trusted channel 335 has one endpoint in the WWAN authentication software 319 and the other endpoint within the WWAN module 270 (either hardware or firmware). Similarly, the trusted channel 340 has one endpoint in the WLAN authentication software 321 and the other endpoint within the WLAN module 290. It will be appreciated that for some embodiments, the WLAN trusted channel may not be included.

To provide one or more of the trusted channels 335 and 340, either or both of the WWAN and/or WLAN authentication software modules 319 and/or 321 may use any one of a number of approaches to provide for protected communications including, for example, per packet encryption, Message Authentication Code (MAC), Transport Layer Security and/or mutual authentication. Other approaches for providing for protected communications are within the scope of various embodiments.

Referring to FIGS. 2 and 3, in operation, the WWAN and/or WLAN authentication software 319 and/or 321 may communicate with the SIM access module 323 to access the SIM card 278 through the SIM reader 276 for authentication and for checking SIM presence periodically. For example, where the WWAN module 270 is used as a wireless access point or in another manner for wireless communications, prior to a service provider allowing communications with the WWAN module 270 and/or making services, data or applications available to the computing system 200 via the WWAN module 270, credentials stored on the SIM card 278 may be verified. As mentioned above, some types of communications and services, such as GSM communications, for example, may further require the SIM card 278 to remain in place through the communications. This presence may be verified via the WWAN authentication software.

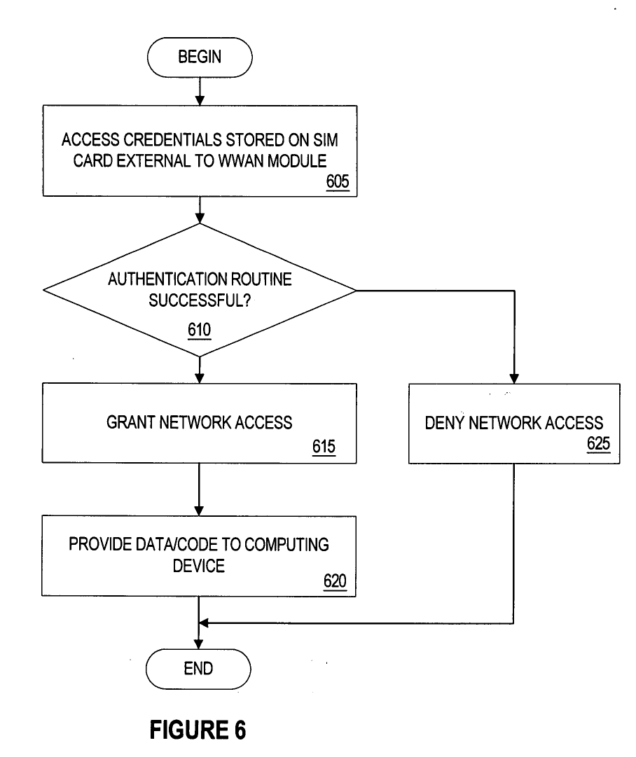

For example, referring to FIG. 6, at block 605, in response to receiving a network access request, a service provider may access credentials stored on a SIM card that accessible via a SIM reader, where the SIM reader is external to a WWAN module that will be used to provide communication over the network. The service provider may provide, for example, GSM/GPRS communications and/or communications and/or data over a different type of network.

At block 610, it is determined whether an authentication routine using the accessed credentials has been successfully completed. If so, then at block 615, access to the network and/or associated services is granted. Optionally, at block 620, the service provider may transfer information to a computing device that includes the WWAN module and the SIM reader. Such information may be used to provide code updates, perform manageability functions, etc. If the authentication routine is not successfully completed, then at block 625, access to the network may be denied and/or another attempt to authenticate may be initiated.

It will be appreciated that other actions may be performed by the service provider in response to accessing credentials that are stored on a SIM card outside of a WWAN module via which communications with the service provider are established.

With the trusted paths provided between the SIM card 278 and the protected partition of the computing system 200, and the protected path between the WWAN module 270 and the WWAN authentication software as described above, such a usage model is possible, even with the SIM reader 276 external to the WWAN module or other ME module 270 as shown in FIG. 2. In this manner, strong user authentication may be provided for multiple wireless networks using industry-standard or other Authentication, Authorization and Accounting (AAA) methods.

Embodiments, such as the one shown in FIG. 2, may provide such capabilities, while still providing for secure communications and operations. In some cases and for some embodiments, the security provided by the platform 200 of FIG. 2 for wireless communications may be considered to be even more robust than the current wireless telephone platform.

Further, by providing the SIM reader 276 outside of the WWAN module 270 in the system 200, it may be possible to use the SIM reader 276 for other types of applications in addition to WWAN module authentication such as, for example, wireless local area network (WLAN) communications according to the EAP-SIM (Extensible Authentication Protocol) or another protocol. Other uses for the SIM reader 276 are also possible such as authentication for particular applications or other devices, for example.

As mentioned previously, in current practice, each WWAN or other ME module that is to be sold commercially needs to pass Formal Type Approval (FTA) testing prior to sale. For wireless telephones, where the SIM or other credential reader is within the ME, the entire handset is typically provided to an FTA test house for FTA testing. For certification of computing systems, such as the computing system 200 of FIG. 2, however, it may not be possible or practical to provide an entire computing system for FTA certification each time a new platform is launched.

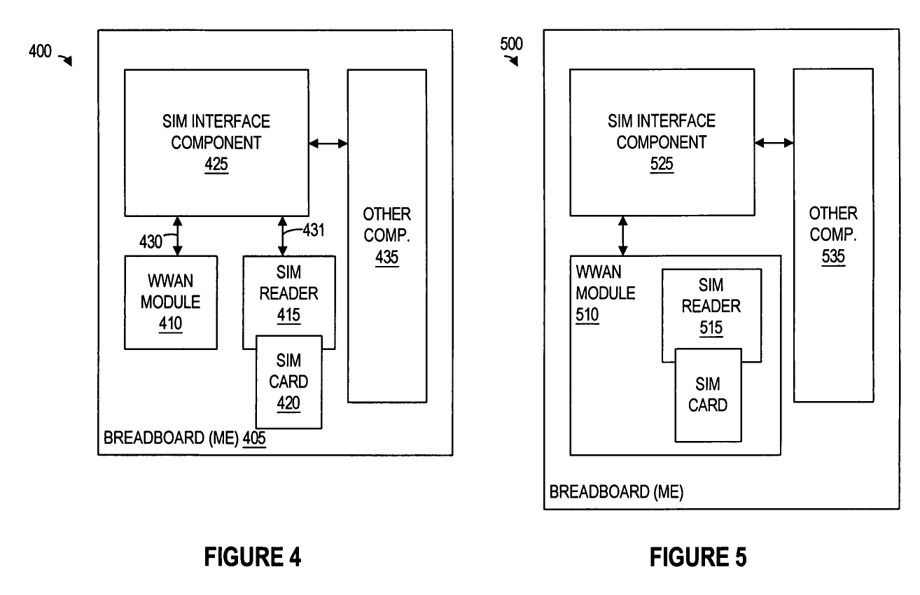

The test set-up of FIG. 4 illustrates one approach to addressing this issue. FIG. 4 is a block diagram of an exemplary test platform 400 of one embodiment, which may be used by FTA test houses or other test facilities, for example, to perform FTA certification on WWAN modules such as WWAN modules of the systems 100 or 200 of FIG. 1 or 2, respectively. The platform 400 may also be useful for other types of testing for some embodiments such as, for example, operator-specific tests, industry-specific certifications and/or geography-specific testing.

The exemplary test platform 400 may be configured on a breadboard 405, which, to the FTA test house or other testing facility, represents the ME for which the testing is to be performed. The WWAN module or other ME 410 to be certified is coupled to the breadboard 405 in a conventional manner, as is the associated SIM reader 415 that receives a SIM card 420 to be used during certification testing.

A SIM or other identity module interface component 425 is coupled to the WWAN module 410 and the SIM reader 415 over buses 430 and 431. For some embodiments, such as those for which the WWAN module 410 is similar to the WWAN module of FIG. 1 or 2, one or both of the buses 430 and 431 may be USB connections, for example. Other types of buses, such as, for example, PCIE buses, may be used for one or more of the buses 430 and 431 for different system configurations.

At a minimum, the SIM interface component 425 provides the necessary software and/or hardware to facilitate communications between the WWAN module 410 and the SIM reader 415 in a manner that emulates the same communications in the platform to be certified. In this manner, the actual PC components for each different platform in which the WWAN or other ME module to be certified is to be used do not necessarily need to be included in the test platform. This may be particularly advantageous where certain system components are still in development, for example, and it is desirable to have the FTA certification process performed before they are available.

For example, where the WWAN module 410 is the WWAN module 270 of FIG. 2, the SIM interface component 425 and, for some embodiments, additional glue logic or other components 435, emulate the SIM-WWAN module communications interface provided by the platform 200 and associated operating environment. For embodiments for which components of the system 200 include Lagrande technology (LT) and the operating system 292 provides for protected execution, the SIM interface component 425 may run the same operating system 292 and the same drivers 295 that will be used in the system 200 for the associated SIM reader 276 and WWAN module 270. At least the LT features that are used in SIM-WWAN module communications are also included. In this manner, the chipset and processor hardware, for example, in the test platform 400 and the system 100 or 200 do not need to be identical.

For one embodiment, the SIM interface component 425 may be provided by a notebook or desktop computing platform or a computing system motherboard, for example. For current FTA tests, any notebook or motherboard on which the drivers that will be used in the system with the WWAN module to be certified may be used to provide the SIM interface component 425.

The test platform 400 is versatile enough such that it may be used, with only minor modifications to the configuration, to perform testing on WWAN or ME modules where the SIM reader is external to the module (as shown in FIGS. 1 and 2), where the SIM reader is internal to the WWAN module, and even for configurations for which the SIM reader is external to the platform.

For example, FIG. 5 shows a modified version of a test platform 500 for a configuration in which the SIM reader 515 is internal to the WWAN or other ME module 510, and the WWAN module 510 is to be used in a computing system platform. For the embodiment of FIG. 5, as for the embodiment of FIG. 4, the SIM interface component 525 may be provided by any system or motherboard that is capable of running the drivers that will be used for the WWAN module 510 and/or the SIM reader 515 in commerce and that is capable of emulating the communication between the WWAN module 510 and the SIM reader 515. For the embodiment of FIG. 5, as for the embodiment of FIG. 3, in some cases, some additional glue logic 535 may also be used.

For other embodiments, the test set-up may be adjusted to emulate a system in which multiple SIM and/or smart card readers, for example, may be implemented. Other adjustments to the test platform are within the scope of various embodiments.

The exemplary test platforms of FIGS. 4 and 5 may be used to run currently existing FTA certification or other test suites that perform a variety of tests including checking for SIM presence, checking the SIM/ME (or SIM/WWAN module) interface, checking for support of various protocols, etc. For some embodiments, it may be desirable to provide additional tests to be performed to indicate a higher level of functionality or an enhanced feature set, such as additional security measures, for example. Such tests may also be performed on the test platforms of various embodiments.

Using the test platform of one or more embodiments, it may be straightforward to provide for FTA or other types of testing without having to provide a new notebook or other computing system platform for each new computing system platform to be launched. So long as the testing platform emulates the environment in which the WWAN or other ME module is to be used, including the SIM/WWAN module interface and associated drivers, it may be used for various types of testing. In other words, the device drivers for WWAN and SIM modules may need to be included as part of the system configuration for FTA certification testing, although other hardware and/or software component such as CPU, chipset, general software, operating system, other drivers, etc. need not be included in the FTA certification process except, in some cases, as part of the breadboard system for the WWAN and SIM components to be certified.

Thus, various embodiments of a system including a WWAN module associated with an external Subscriber Identity Module (SIM) or other type of credential or identity module reader and approach for certifying the WWAN module are described. In the foregoing specification, the invention has been described with reference to specific exemplary embodiments thereof. It will, however, be appreciated that various modifications and changes may be made thereto without departing from the broader spirit and scope of the invention as set forth in the appended claims. For example, while the exemplary embodiments described above refer to the use of SIM capabilities in association with wireless network use and/or access, the claimed SIM capabilities may be used in conjunction with other types of applications including, for example, wired network access, AAA capabilities for applications, etc. The specification and drawings are, accordingly, to be regarded in an illustrative rather than a restrictive sense.

1. An apparatus comprising:
a wireless wide area network (WWAN) module to provide for wireless communications;
an identity module reader external to and accessible by the WWAN module, the identity module reader to receive an identity card to provide credentials to be accessed by the WWAN module.

2. The apparatus of claim 1 wherein the WWAN module is coupled to one of a Universal Serial Bus (USB) and a Peripheral Component Interconnect Express (PCIE) bus.

3. The apparatus of claim 2 wherein the identity module reader is coupled to one of a USB, a PCIE bus and a wireless link.

4. The apparatus of claim 1 further including
an identity card access module to control accesses by the WWAN module to the identity module reader; and
a WWAN authentication module to provide a trusted channel between the WWAN module and trusted software.

5. The apparatus of claim 4 wherein the WWAN authentication module is further to communicate with the identity card access module to check for identity card presence.

6. The apparatus of claim 4 wherein the WWAN authentication module is further to communicate with the identity card access module to access the identity card for authentication purposes.

7. The apparatus of claim 1 wherein the identity card is one of a set including a Subscriber Identity Module (SIM) card, a Universal SIM (USIM) card, a removable user identity module (R-UIM) card and a Universal Serial Bus (USB) Integrated Chip Card (UICC).

8. A system comprising:
a processor to process instructions, the processor to support a protected partition for protected execution;
a chipset coupled to the processor;
a wireless wide area network (WWAN) module coupled to the chipset; and
a credential reader coupled to chipset and external to the WWAN module, the credential reader to receive a credential module storing credentials to be accessed by the WWAN module.

9. The system of claim 8 wherein the WWAN module is coupled to the chipset over one of a Universal Serial Bus (USB) and a Peripheral Component Interconnect Express (PCIE) bus.

10. The system of claim 9 wherein the credential reader is a Subscriber Identity Module (SIM) reader and the credential module is a SIM card.

11. The system of claim 8 wherein the credential module is one of a set including a Subscriber Identity Module (SIM) card, a Universal SIM (USIM) card, a removable user identity module (R-UIM) card and a Universal Serial Bus (USB) Integrated Chip Card (UICC).

12. The system of claim 8 wherein the processor implements Lagrande technology (LT) to support the protected partition.

13. The system of claim 12 wherein the processor is further to run an operating system that provides for protected execution.

14. The system of claim 8 wherein the processor is further to execute
a credential reader access module to provide a trusted path between the credential reader and the protected partition; and
a WWAN authentication module to provide a trusted path between the WWAN module and the protected partition.

15. The system of claim 14 wherein
the WWAN authentication module is further to communicate with the credential reader access module to access the credential reader for authentication and to check for presence of the credential module.

16. The system of claim 8 further including a hardware token coupled to the chipset.

17. The system of claim 16 wherein the hardware token is a Trusted Platform Module (TPM).

18. A method comprising:
providing a first trusted path between a Subscriber Identity Module (SIM) reader and a SIM access module;
providing a second trusted path between a wireless wide area network (WWAN) module and a WWAN authentication module; and
providing for communications between the SIM reader and the WWAN module over the first and second trusted paths.

19. The method of claim 18 further comprising:
determining whether a SIM card is present by communicating with the SIM reader via the SIM access module using the WWAN authentication module.

20. The method of claim 18 further comprising:
accessing the SIM card via the SIM reader and the SIM access module to perform an authentication operation.

21. A method comprising:
accessing credentials on a SIM card on a computing device via a SIM reader, the SIM reader being external to an associated wireless wide area network (WWAN) module;
determining that an authentication routine using the accessed credentials has completed successfully; and
providing access to a network via the WWAN module in response to successful completion of the authentication routine.

22. The method of claim 21 further comprising:
denying access to the network in response to unsuccessful completion of the authentication routine.

23. The method of claim 21 further comprising:
providing one of data and code over the network to the computing device after network access has been provided.

24. An apparatus comprising:
a wireless wide area network (WWAN) module coupled to a bus;
a Subscriber Identity Module (SIM) reader external to the WWAN module and accessible by the WWAN module, the SIM reader to receive a SIM card storing credentials to be accessed by the WWAN module; and
a SIM interface component coupled to the WWAN module and SIM reader, the SIM interface component to substantially emulate an interface between the WWAN module and the SIM reader in a computing platform in which the WWAN module and SIM reader are to be implemented.

25. The apparatus of claim 24 wherein the bus is one of a Universal Serial Bus (USB) and a Peripheral Component Interconnect Express (PCIE) bus.

26. The apparatus of claim 24 wherein the SIM interface component comprises at least a computing platform; a SIM reader driver for the SIM reader and a WWAN module driver for the WWAN module.

27. The apparatus of claim 24 wherein the WWAN module, the SIM reader and the SIM interface component are further to be evaluated using Formal Type Approval (FTA) certification routines to certify the WWAN module.

28. The apparatus of claim 27 wherein
the SIM interface module includes one of a processor and a chipset other than a processor and a chipset to be used with the WWAN module in a commercially available system.
